(19) United States
(12) Patent Application Publication
(10) Pub. No.: US 2025/0187553 A1
(43) Pub. Date: Jun. 12, 2025

(54) DIGITAL LICENSE PLATE FRAME

(71) Applicant: Camisasca Automotive Manufacturing, Inc., Lake Forest, CA (US)

(72) Inventor: Colin H. Camisasca, Newport Beach, CA (US)

(21) Appl. No.: 18/975,686

(22) Filed: Dec. 10, 2024

Related U.S. Application Data
(60) Provisional application No. 63/608,735, filed on Dec. 11, 2023.

(51) Int. Cl. B60R 13/10; G09F 7/18

(52) U.S. Cl. CPC B60R 13/105; G09F 7/18; G09F 2007/1843; G09F 2007/1895

(57) ABSTRACT

A digital license plate cover can include a front plate having a cut out portion. A digital license plate cover can include a plurality of side walls connected to a perimeter of the front plate, wherein the plurality of side walls include a top wall connected to a top portion of the front plate and a bottom wall connected to a bottom portion of the front plate. The plurality of side walls can be perpendicular to the front plate. The digital license plate cover can include at least one tab connected to the top wall, wherein the at least one tab is configured to at least partially secure a digital license plate to the digital license plate cover.

### PRIORITY AND INCORPORATION BY REFERENCE

This application is related to and claims the benefit of U.S. Provisional Application No. 63/608,735, filed Dec. 11, 2023, the entirety of which is incorporated by reference herein and made a part of the present disclosure. This application also incorporates by reference in their entireties U.S. patent application Ser. No. 12/724,263, filed Mar. 15, 2010, now U.S. Pat. No. 8,051,690 and titled “ANTI-THEFT THREADED CAP,” and U.S. patent application Ser. No. 16/021,895, filed Jun. 28, 2018, now U.S. Pat. No. 10,843,642 and titled “LICENSE PLATE FASTENER HEAD CAP ASSEMBLY.”

### BACKGROUND

### Field

The present disclosure relates to license plate frame. In particular, the present disclosure relates to digital license plate frames for a vehicle.

### Description of the Related Art

Existing license plate frames fail to accommodate new digital license plates and their mounting system. Existing license plate frames have other disadvantages, such as requiring more hardware than necessary, being bulk, being expensive, and/or overly complicated to install, for example.

### SUMMARY

In some aspects, the present disclosure relates to a digital license plate cover, which includes a front plate and a plurality of side walls. The front plate has a cut out portion configured to expose at least a portion of a digital license plate that underlies the digital license plate cover. The plurality of side walls are connected to a perimeter of the front plate. The plurality of side walls comprises a top wall connected to a top portion of the front plate and a bottom wall connected to a bottom portion of the front plate. The plurality of side walls are perpendicular to the front plate. At least one tab is connected to the top wall or to the bottom wall. The at least one tab is configured to at least partially secure a digital license plate to the cover.

In some configurations, the bottom portion of the front plate comprises at least one mounting feature configured to allow both the digital license plate cover and the digital license plate to be secured to a vehicle.

In some configurations, the at least one mounting feature comprises a pair of holes configured to receive a fastener.

In some configurations, each of the pair of holes align with corresponding holes in the digital license plate.

In some configurations, a fastener extends through each of the pair of holes, wherein the fastener is secured with an anti-theft assembly comprising a base and a cap that cooperate to define an interior space that receives a head of the fastener.

In some configurations, the at least one tab is parallel to the front plate.

In some configurations, the at least one tab consists of a single individual tab.

In some configurations, the at least one tab comprises between 1 and 5 individual tabs.

In some configurations, a width of the plurality of side walls is at least 4 mm, wherein the width is defined by a distance from the perimeter of the front plate to a free end of the plurality of side walls.

In some configurations, a width of the top wall or the bottom wall is at least 4 mm, wherein the width is defined by a distance from the perimeter of the front plate to a free end of the top wall or the bottom wall.

In some configurations, the front plate includes one or more mounting holes below a lowermost extent of the cut out portion and does not include any mounting holes above the lowermost extend of the cut out portion or the front plate includes one or more mounting holes above a lowermost extent of the cut out portion and does not include any mounting holes below the lowermost extend of the cut out portion.

In some configurations, the at least one tab can be located opposite the mounting holes.

In some configurations, the front plate includes one or more mounting holes in an upper half or a lower half of the front plate and does not include any mounting holes in the other half of the front plate.

In some configurations, the at least one tab can be located opposite the mounting holes.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 illustrates an exploded view of the digital license plate cover system.

FIG. 2 illustrates a front view of the digital license plate cover.

FIG. 3 illustrates a rear view of the digital license plate cover.

FIG. 4 illustrates a side view of the digital license plate cover.

FIG. 5 illustrates a sectional side view of the digital license plate cover.

FIG. 6 illustrates a rear view of the digital license plate cover and the digital license plate.

FIG. 7 illustrates a front view of the digital license plate cover and the digital license plate.

FIG. 8 illustrates a front view of the digital license plate cover and the digital license plate mounted to the digital license plate mounting plate.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The present disclosure relates to a license plate frame or cover or a license plate frame or cover system. More specifically, the present disclosure relates to an electronic or digital license plate frame or cover or an electronic or digital license plate frame or cover system. Hereinafter, the term “cover” is used for convenience. However, instances of the term “cover” can be replaced with the term “frame.” Similarly, the term “digital” is used hereafter, but could be replaced with the term “electronic.” The digital license plate cover is designed to cover at least a portion of a digital license plate, while maintaining a sleek and minimalist look. The digital license plate cover also serves to protect and, optionally, provide security to the digital license plate. The digital license plate cover may optionally provide a surface or location for branded graphics. In the illustrated arrangement, the digital license plate cover includes a front plate portion, or front plate, that includes a cutout. The cutout is configured to display the screen or at least a portion of the screen of the digital license plate. The cut out may be rectangular or it may be an alternative shape, such as an oval or a polygon. The corners of the rectangular cutout may be chamfered or filleted. Furthermore, the outside corners of the digital license plate cover can be rounded or otherwise chamfered.

The digital license plate cover can comprise a plurality of side wall portions or side walls connected to the front plate. The plurality of walls may be connected to the front plate at an angle between 70 and 110 degrees. In some configurations, the angle between the front plate and the side walls can be 90 degrees or about 90 degrees. In some configurations, it is preferred for the angle to be 90 degrees or slightly greater, such as between 90-95 degrees to facilitate assembly of the digital license plate cover to the digital license plate and/or to ease the manufacturing process. The plurality of side walls can extend in a rearward direction from the front plate. When the front plate is rectangular, there may be four side walls. A top wall connected to a top portion or edge of the front plate, a bottom wall connected to a bottom portion or edge of the front plate, and first side wall connected to a first side portion or edge of the front plate, and a second side wall connected to a second side portion or edge of the front plate. The term “side wall” can generically refer to any side wall portion or can refer to the first and second side walls (as contrasted with the top and bottom walls), which will be clear from the context of use. The width of each side wall may be defined distance from the front surface of the front plate, at a connection to the front plate, to a terminus of the wall. The width of the side wall(s) can also define a depth of the digital license plate cover. Thus, a maximum side wall width can define a maximum depth of the digital license plate cover and a minimum side wall width can define a minimum depth of the digital license plate cover. Each side wall can have the same width. Alternatively, the width of at least some of the side walls can vary. For example, each side wall may have a different width, or some side walls can have the same width and one or more other side walls can have a different width. For example, the top and bottom side walls can have a larger (or smaller) width than the first and second side walls. The width may be between 4 and 8 mm, 5 and 7 mm, or 5.5 and 6.5 mm. The width of any individual side wall may be at least 4 mm, 5 mm, 6 mm, or 7 mm. In some cases, the maximum width of any side wall can be 7 mm, 10 mm, 12 mm, or 15 mm.

One or more of the side walls can include a tab or a plurality of tabs. The tab or each tab may be connected to the side wall at an angle between 70 and 110 degrees such that it extends substantially parallel to the front plate towards the center of the front plate. In some configurations, the angle between the tab and the side wall can be between 90-95 degrees, or about or slightly greater than 90 degrees. The tabs can have a width between 2 mm and 20 mm, 2 mm and 10 mm, or 2 mm and 7 mm and a length between 3 mm and 50 mm, 5 mm and 20 mm, or 5 mm and 12 mm. The tab(s) can be configured to contact and/or secure the top portion of the digital license plate cover to the digital license plate. The tab(s) could also be configured to contact and/or secure the digital license plate cover to a mounting plate for the digital license plate. In some embodiments, when the digital license plate cover tab(s) are secured to the digital license plate mounting plate, the digital license plate may be encapsulated, partially encapsulated, secured, or affixed by the digital license plate cover. The tab(s), in combination with the top wall, can wrap around the top portion of the digital license plate such that the top wall restricts movement of the digital license plate in a first direction (e.g., upward or towards the top wall) and the tab(s), in combination with the front plate, restricts movement of the digital license plate in a second direction (e.g., forward-rearward), which may be substantially perpendicular to the first direction. As noted above, the digital license plate cover can have a single tab or a plurality of tabs. The tabs may be configured to interact with a back surface of the digital license plate. Specifically, the tabs may be configured to interact with a rear surface of the digital license plate such that they do not interfere with the digital license plate's mounting system.

The digital license plate may be configured to connect with a top portion of the digital license plate mounting plate via a clip or a hinge type connection, and the bottom portion may be secured via mechanical fasteners, such as screws. The reference to screws herein may refer to any connection type, including those incorporated by reference herein. In some configurations, the digital license plate cover can be designed to integrate with the connection arrangement of the digital license plate to the digital license plate mounting plate such that no additional hardware or modifications are needed. The front plate of the digital license plate cover can have two apertures or holes that align with the mounting holes of the digital license plate. The holes may be located on the lower portion of the front plate such that they are between the bottom perimeter and the cut out. The digital license plate cover and the digital license plate may have more than two holes or less. Further, the number of holes on the digital license plate cover may be the same as the number of holes on the digital license or plate, but they need not be. In some configurations, the at least one tab is located on a side wall that is opposite the location of the mounting holes on the digital license plate cover and/or the digital license plate. For example, in the arrangement illustrated herein, the at least one tab is located on the top wall and the mounting holes are located on the bottom of the front plate of the digital license plate cover and the bottom portion of the digital license plate. However, this arrangement could be reversed from that shown and position the mounting holes at the top of the front plate and the at least one tab on the bottom wall of the digital license plate cover.

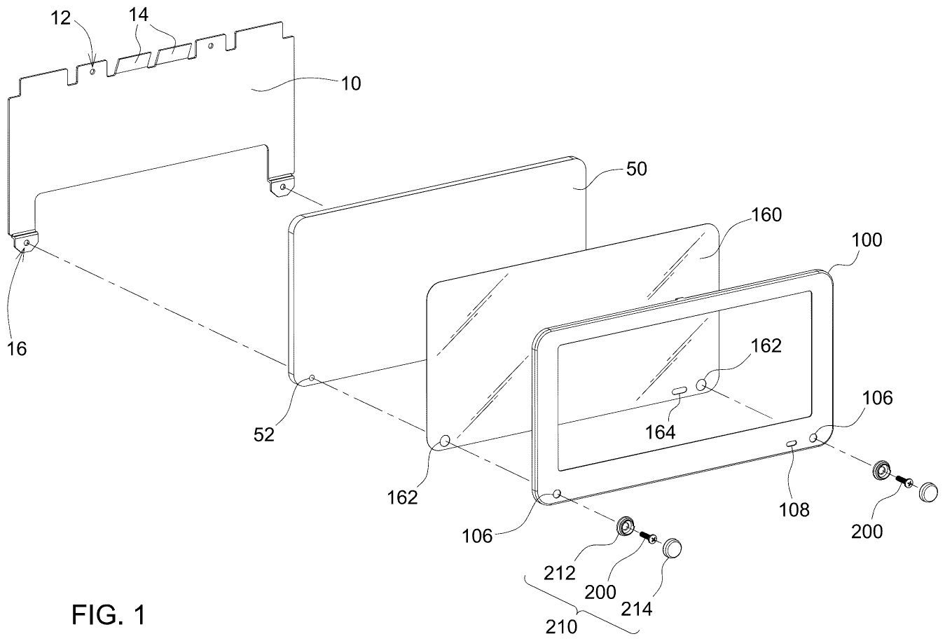

FIG. 1 illustrates an exploded view of the digital license plate system, which as illustrated includes the digital license plate mounting plate 10, the digital license plate 50, an optional protector shield 160, the digital license plate cover 100, and fasteners or fastener assemblies 200. The digital license plate 50 is supported by the digital license plate mounting plate 10. The digital license plate cover 100 is secured to both the digital license plate 50 and the digital license plate mounting plate 10. The optional protector shield 160 can be positioned between the digital license plate 50 and the digital license plate cover 100. The optional protector shield 160 can be a relatively thin, rigid, and clear or transparent (or substantially clear or transparent) plate having an outer shape that matches outer shape of the digital license plate 50 and/or the shape defined by the interior surface of the side walls of the digital license plate cover 100. The optional protector shield 160 can include a pair of mounting openings 162 and an access opening 164 that align with a respective one of a pair of bottom mounting features 106 and an access opening 108 of the digital license plate cover 100.

The digital license plate mounting plate 10 includes a first mounting hole set 12 configured to hold the digital license plate mounting plate 10 to a vehicle. The digital license plate mounting plate 10 further includes a first digital license plate holding feature or features 14, which can be in the form of a tab. The first digital license plate holding feature(s) 14 may engage the digital license plate, specifically the back of the digital license plate 50, and allow it to hinge about the connection or engagement point or axis. The digital license plate mounting plate 10 further includes a second digital license plate holding feature 16. The second digital plate licensing feature 16 may be configured to secure a bottom portion of the digital license plate 10. The second digital plate licensing feature 16 may be a plurality of threaded screw holes that align with corresponding holes 52 in the digital license plate 50.

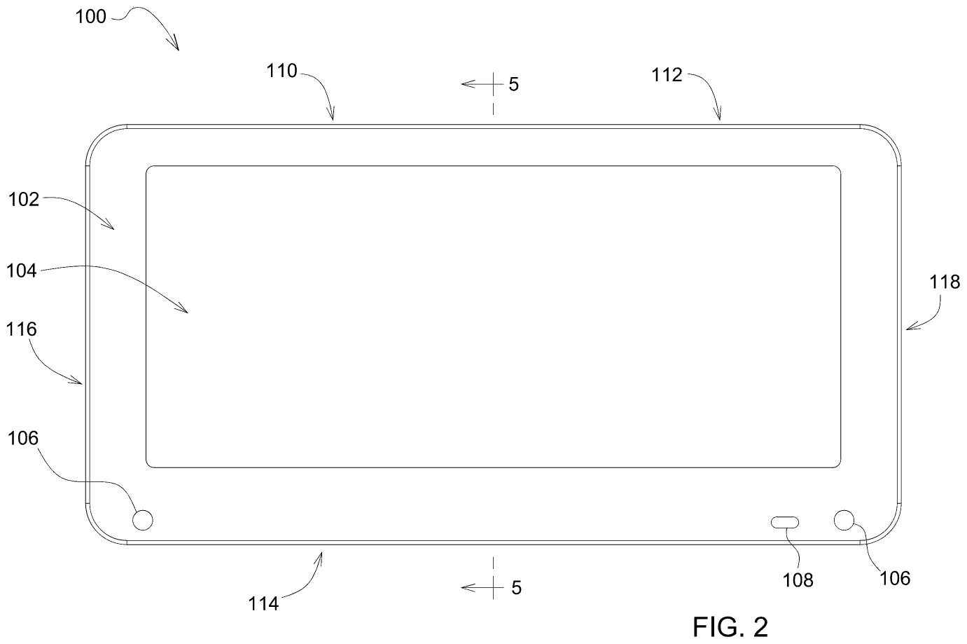

FIG. 2 illustrates a front view of the digital license plate cover 100. The digital license plate cover 100 includes a front plate 102 with a cutout 104. The front plate 102 may be a substantially flat plate having a flat front surface. The front plate 102 can include a bottom mounting feature 106. The bottom mounting feature 106 may be a hole, or a pair of holes, configured to receive a fastener, such as a screw or bolt. The screw hole or bottom mounting feature 106 may align with the corresponding hole 52 in the digital license plate 50 and the second digital plate licensing feature 16. A fastener, such as screw 200, can secure the digital license plate cover 100 and the digital license plate 50 to the digital license plate mounting plate 10. In some configurations, the front plate 102 includes only a bottom mounting feature 106 consisting of two mounting holes, such that there are no other mounting features or holes in the front plate 102. The bottom mounting feature 106 can be located below a lowermost extent of the cutout 104. In some configurations, there are no mounting features in a top portion of the front plate 102 above an uppermost extent of the cutout 104. In some configurations, there are no mounting features in a portion of the front plate 102 above the lowermost extent of the cutout 104. As mentioned previously, the digital license plate cover 100 can include an access opening 108, which can permit access to a portion of the digital license plate 50, such as a button or other input device. The access opening 108 can be located in any suitable location on the digital license plate cover 100, including above the lowermost extent or the uppermost extent of the cutout 104. However, the access opening 108 is not a mounting feature.

The digital license plate cover 100 can further include a perimeter 110, which can be formed in whole or in part by a side wall. The digital license plate cover 100 or the perimeter 110 can include a top connection 112, a bottom connection 114, a first side connection 116, and a second side connection 118. Each connection 112, 114, 116, and 118 couples the front plate 102 to a respective portion of the side wall. Each of the connections 112, 114, 116, and 118 can be curved to provide an attractive transition between the front plate 102 and the side wall.

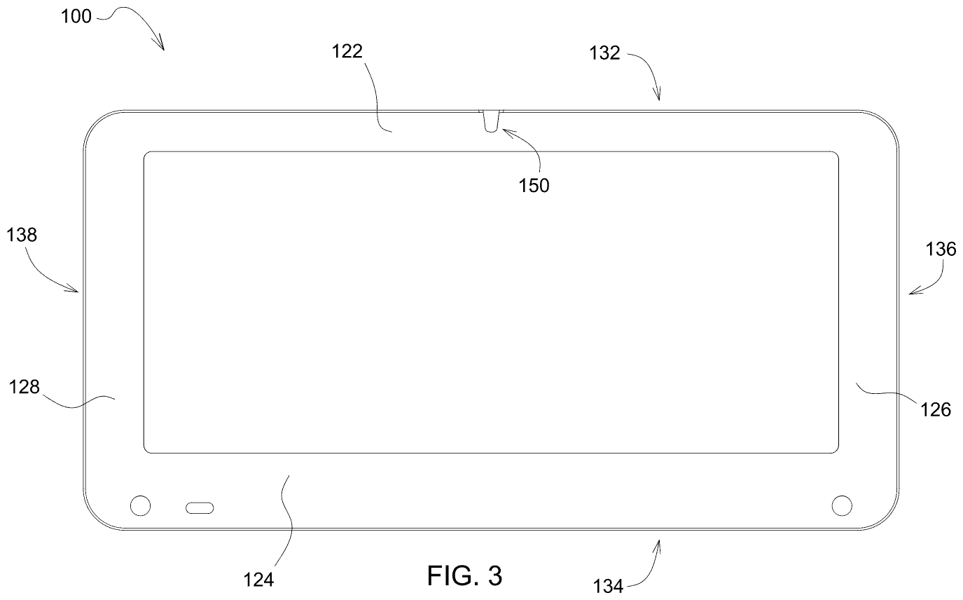

FIG. 3 illustrates a rear view of the digital license plate cover 100. The side wall of the digital license plate cover 100 includes a top wall 132 connected to a top portion 122 of the front plate 102 by the top connection 112, a bottom wall 134 connected to a bottom portion 124 of the front plate 102 by the bottom connection 114, a first side wall 136 connected to a first side portion 126 of the front plate 102 by the first side connection 116, and a second side wall 138 connected to a second side portion 128 of the front plate 102 by the second side connection 118. The digital license plate cover 100 further includes the tab 150. The tab 150 is connected to the top wall 132. In other configurations, the tab 150 may be connected to the top wall 132, the bottom wall 134, the first side wall 136, or the second side wall 138. There may be a single tab 150, as shown in the present embodiment, or there may be multiple tabs 150. In some configurations, there is a single tab 150 located opposite the mounting feature 106. In the illustrated arrangement, that means the single tab 150 is located on the top wall 132 of the digital license plate cover 100.

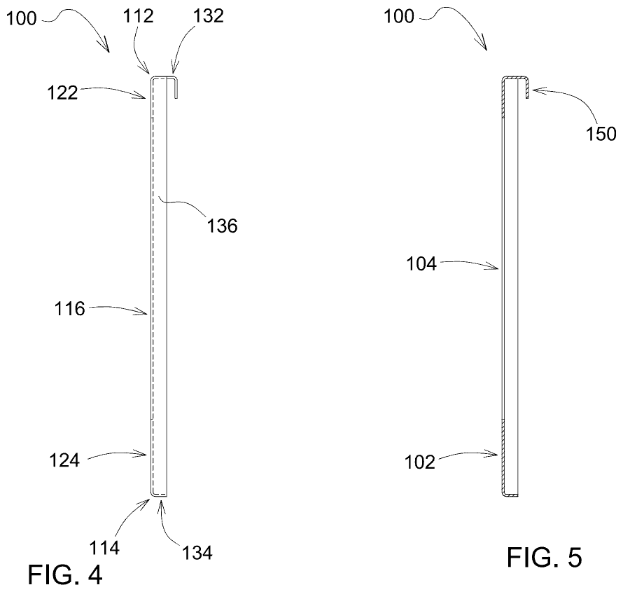

FIG. 4 illustrates a side view of the digital license plate cover 100. FIG. 5 illustrates a sectional side view of the digital license plate cover 100 as indicated by cut line of FIG. 2. The tab 150 of the digital license plate cover 100 can extend substantially parallel to the front plate 102. The tab 150 can be within 10 degrees or 5 degrees of parallel relative to the front plate 102. In some configurations, the tab 150 is within 2 degrees of parallel relative to the front plate 102.

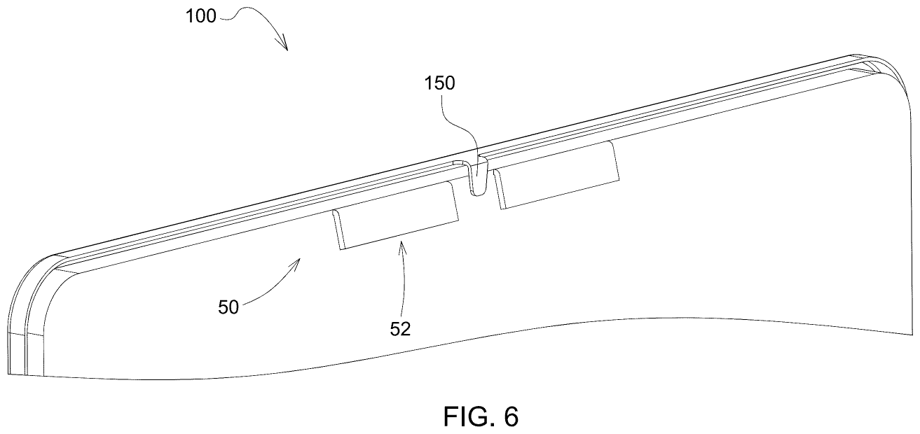

FIG. 6 illustrates a rear perspective view of the digital license plate cover 100 and the digital license plate 50. The digital license plate 50 can include a first holding feature 52 which corresponds to and cooperates with a first digital license plate holding feature 14. The tab 150 of the digital license plate cover 100 secures the digital license plate cover 100 to the digital license plate 50. The tab 150 is located such that it does not interfere with the first holding feature 52 or the mounting of the digital license plate 50 to the digital license plate mounting plate 10.

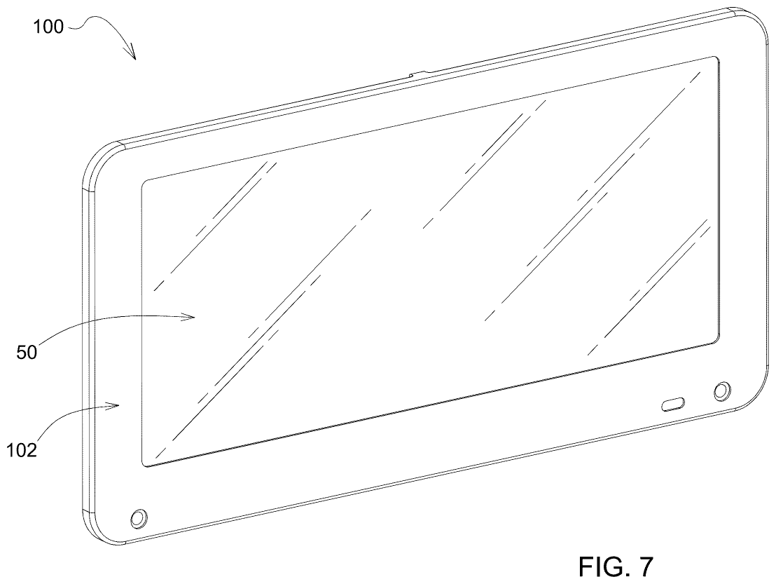

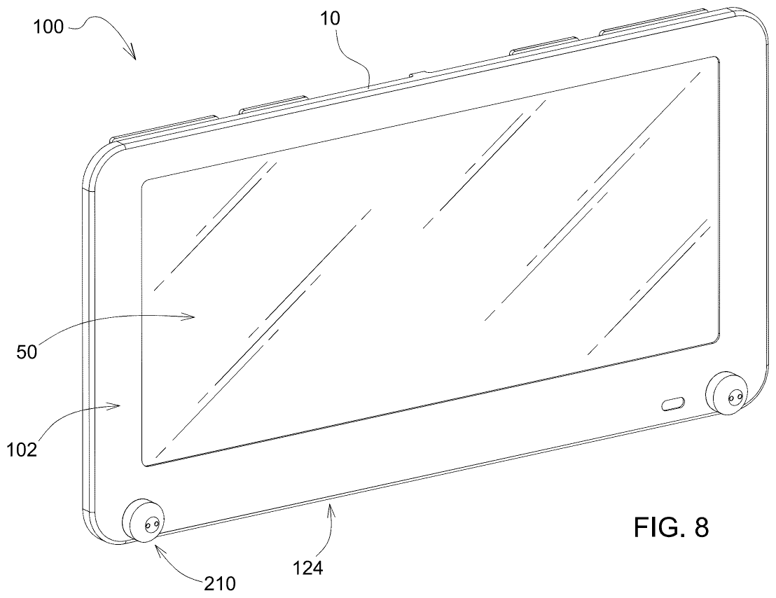

FIG. 7 illustrates a front perspective view of the digital license plate cover 100 and the digital license plate 50 without fasteners 200 (FIG. 1). FIG. 8 illustrates a front perspective view of the digital license plate cover 100 and the digital license plate 50 mounted to the digital license plate mounting plate 10 by fasteners 200 (FIG. 1). In the illustrated arrangement, the fasteners 200 pass through the digital license plate cover 100 and the digital license plate 50 and are secured into the digital license plate mounting plate 10. The fasteners 200 can pass through the bottom portion 124 of the front plate 102, as described previously. Optionally, and as shown in the illustrated arrangement, the fasteners 200 can also pass through a security or anti-theft hardware arrangement 210 including a base 212 that can be closed by a cooperating cap 214 (FIG. 1). The security or anti-theft hardware arrangement 210 can be as shown and described in U.S. Pat. No. 8,051,690 or U.S. Pat. No. 10,843,642, or can be of another suitable arrangement.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A digital license plate cover, comprising:
a front plate having a cut out portion configured to expose at least a portion of a digital license plate that underlies the digital license plate cover;
a plurality of side walls connected to a perimeter of the front plate;
wherein the plurality of side walls comprises a top wall connected to a top portion of the front plate and a bottom wall connected to a bottom portion of the front plate;
wherein the plurality of side walls are perpendicular to the front plate;
at least one tab connected to the top wall;
wherein the at least one tab is configured to at least partially secure a digital license plate to the cover.

2. The digital license plate cover of claim 1, wherein the bottom portion of the front plate comprises at least one mounting feature configured to allow both the digital license plate cover and the digital license plate to be secured to a vehicle.

3. The digital license plate cover of claim 2, wherein the at least one mounting feature comprises a pair of holes configured to receive a fastener.

4. The digital license plate cover of claim 3, wherein each of the pair of holes align with corresponding holes in the digital license plate.

5. The digital license plate cover of claim 4, further comprising a fastener that extends through each of the pair of holes, wherein the fastener is secured with an anti-theft assembly comprising a base and a cap that cooperate to define an interior space that receives a head of the fastener.

6. The digital license plate cover of claim 1, wherein the at least one tab is parallel to the front plate.

7. The digital license plate cover of claim 1, wherein the at least one tab consists of a single individual tab.

8. The digital license plate cover of claim 1, wherein the at least one tab comprises between 1 and 5 individual tabs.

9. The digital license plate cover of claim 1, wherein a width of the plurality of side walls is at least 4 mm, wherein the width is defined by a distance from the perimeter of the front plate to a free end of the plurality of side walls.

10. The digital license plate cover of claim 1, wherein a width of the top wall or the bottom wall is at least 4 mm, wherein the width is defined by a distance from the perimeter of the front plate to a free end of the top wall or the bottom wall.

11. The digital license plate cover of claim 1, wherein the front plate includes one or more mounting holes below a lowermost extent of the cut out portion and does not include any mounting holes above the lowermost extend of the cut out portion or the front plate includes one or more mounting holes above a lowermost extent of the cut out portion and does not include any mounting holes below the lowermost extend of the cut out portion.

12. The digital license plate cover of claim 1, wherein the front plate includes one or more mounting holes in an upper half or a lower half of the front plate and does not include any mounting holes in the other half of the front plate.
